(19) United States
(12) Patent Application Publication
(10) Pub. No.: US 2007/0089094 A1
(43) Pub. Date: Apr. 19, 2007

(54) Temporal sample-based profiling

(76) Inventors: Frank Eliot Levine, Austin, TX (US); Clarence Boyd Murrah JR., Round Rock, TX (US); Luc Rene Smolders, Austin, TX (US)

Correspondence Address: IBM CORP (YA);C/O YEE & ASSOCIATES PC, P.O. BOX 802333, DALLAS, TX, 75380, US

(21) Appl. No.: 11/249,935

(22) Filed: Oct. 13, 2005

(51) Int. Cl. G06F 9/44

(52) U.S. Cl. 717/128

(57) ABSTRACT

A computer implemented method, apparatus, and computer usable program code to collect event information in a bucket during execution of code to form collected event information. The collected event information is written in a trace each time a period of time passes. The time period is associated with the event information and the collected event information is cleared from the bucket each time the collected event information is written to the trace.

### BACKGROUND OF THE INVENTION

1. Field of the Invention

The present invention relates generally to an improved data processing system and in particular to an improved computer implemented method and apparatus for processing data. Still more particularly, the present invention relates to a computer implemented method, apparatus, and computer usable program code for collecting data during execution of code.

2. Description of the Related Art

In writing code, runtime analysis of the code is often performed as part of an optimization process. Runtime analysis is used to understand the behavior of components or modules within the code using data collected during the execution of the code. The analysis of the data collected may provide insight to various potential misbehaviors in the code. For example, an understanding of execution paths, code coverage, memory utilization, memory errors and memory leaks in native applications, performance bottlenecks, and threading problems are examples of aspects that may be identified through analyzing the code during execution.

The performance characteristics of code may be identified using a software performance analysis tool. The identification of the different characteristics may be based on a trace facility of a trace system. A trace tool may be used for more than one technique to place information that indicates flows in the execution of code and other aspects of an executing program. A trace may contain data about the execution of code. For example, a trace may contain trace records about events generated during the execution of the code. A trace also may include information, such as, a process identifier, a thread identifier, and a program counter. Information in the trace may vary depending on the particular profile or analysis that is to be performed. A record is a unit of information relating to an event that is detected during the execution of the code.

Sample-based profiling involves taking samples of events. In other words, not every event that occurs may be recorded. Instead, an interrupt may be generated after a number of events occur to generate a sample. In performing sample-based profiling, the current mechanisms use a trace-based mechanism to support this type of profiling. Sample-based profiling is used to determine where the application is executing. One drawback with using samples to profile execution is that the trace data collected may be so large that this data must be written to a device, such as a hard disk, while the tracing takes place. This type of disk access may significantly affect the results of the system being tested. The currently used mechanisms consolidate information by sample addresses to reduce the amount of data collected. In other words, a counter is used to count the number of times that an event occurs at an address. This type of data collection does reduce the amount of data collected during testing to avoid having to write data to a storage device that may affect the results.

This type of approach, however, does not allow for temporal profiling because the distribution of the temporal addresses may vary over time intervals. As a result, obtaining a temporal report is not feasible. A temporal report provides a report of the execution over a period of time within the entire trace. A temporal report is often desirable because identifying events that occur during certain time periods within the overall execution time is desirable for various reasons. For example, an application may execute different jobs during different periods of time. Further, the application may go through different states in which certain modules are loaded and unloaded at different time periods. These different states and changes are often of interest in optimizing the execution of code.

Currently available systems using this approach provide a report that covers the entire execution time. Obtaining temporal reports that cover periods of time during the execution time is unavailable using these systems.

### SUMMARY OF THE INVENTION

The present invention provides a computer implemented method, apparatus, and computer usable program code to collect event information in a bucket during execution of code to form collected event information. The collected event information is written in a trace each time a period of time passes. The time period is associated with the event information, and the collected event information is cleared from the bucket each time the collected event information is written to the trace.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a data processing system in which the aspects of the present invention may be implemented;

FIG. 2 is a block diagram of a data processing system in which aspects of the present invention may be implemented;

FIG. 3 is a diagram illustrating components used in temporal sample-based profiling in accordance with an illustrative embodiment of the present invention;

FIG. 4 is a diagram illustrating an entry in a bucket in accordance with an illustrative embodiment of the present invention;

FIG. 5 is a flowchart of a process for creating entries and placing data in a bucket in accordance with an illustrative embodiment of the present invention;

FIG. 6 is a flowchart of a process used to mark entries as being invalid in response to a memory space change in accordance with an illustrative embodiment of the present invention; and

FIG. 7 is a flowchart of a process for storing data in buckets in accordance with an illustrative embodiment of the present invention.

### DETAILED DESCRIPTION OF THE PREFERRED EMBODIMENT

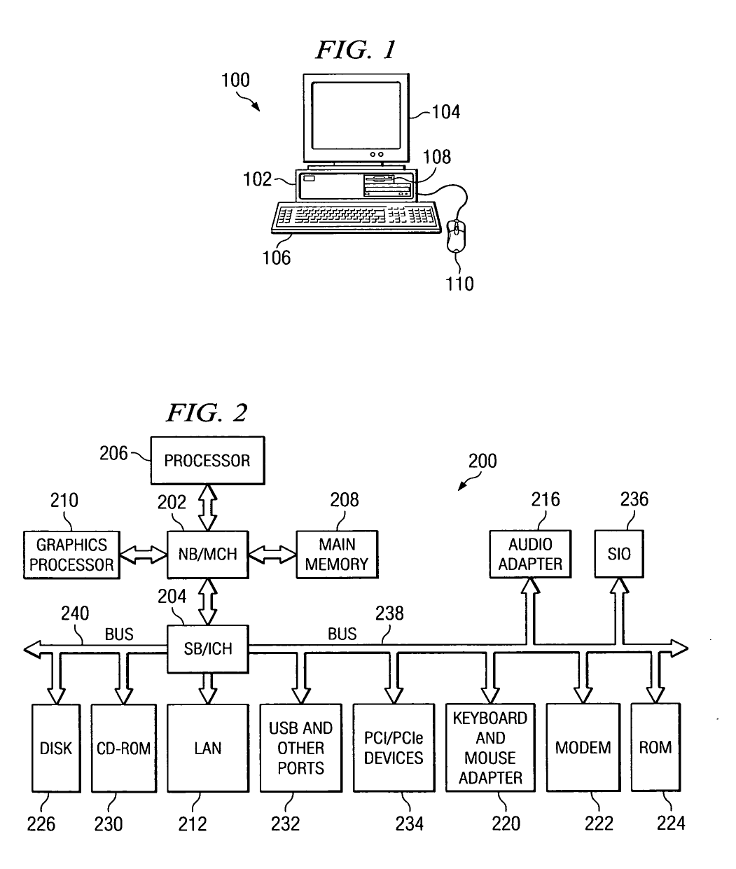

With reference now to the figures and in particular with reference to FIG. 1, a pictorial representation of a data processing system in which the aspects of the present invention may be implemented. Computer 100 is depicted which includes system unit 102, video display terminal 104, keyboard 106, storage devices 108, which may include floppy drives and other types of permanent and removable storage media, and mouse 110. Additional input devices may be included with personal computer 100, such as, for example, a joystick, touchpad, touch screen, trackball, microphone, and the like. Computer 100 can be implemented using any suitable computer, such as an IBM eServer computer or IntelliStation computer, which are products of International Business Machines Corporation, located in Armonk, N.Y. Although the depicted representation shows a computer, other embodiments of the present invention may be implemented in other types of data processing systems, such as a network computer. Computer 100 also preferably includes a graphical user interface (GUI) that may be implemented by means of systems software residing in computer readable media in operation within computer 100.

With reference now to FIG. 2, a block diagram of a data processing system is shown in which aspects of the present invention may be implemented. Data processing system 200 is an example of a computer, such as computer 100 in FIG. 1, in which code or instructions implementing the processes of the present invention may be located. In the depicted example, data processing system 200 employs a hub architecture including a north bridge and memory controller hub (MCH) 202 and a south bridge and input/output (I/O) controller hub (ICH) 204. Processor 206, main memory 208, and graphics processor 210 are connected to north bridge and memory controller hub 202. Graphics processor 210 may be connected to the MCH through an accelerated graphics port (AGP), for example.

In the depicted example, local area network (LAN) adapter 212 connects to south bridge and I/O controller hub 204 and audio adapter 216, keyboard and mouse adapter 220, modem 222, read only memory (ROM) 224, hard disk drive (HDD) 226, CD-ROM drive 230, universal serial bus (USB) ports and other communications ports 232, and PCI/PCIe devices 234 connect to south bridge and I/O controller hub 204 through bus 238 and bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM drive 230 may use, for example, an integrated drive electronics (IDE) or serial advanced technology attachment (SATA) interface. Super I/O (SIO) device 236 may be connected to south bridge and I/O controller hub 204.

An operating system runs on processor 206 and coordinates and provides control of various components within data processing system 200 in FIG. 2. The operating system may be a commercially available operating system such as Microsoft® Windows® XP (Microsoft and Windows are trademarks of Microsoft Corporation in the United States, other countries, or both). An object-oriented programming system, such as the Java™ programming system, may run in conjunction with the operating system and provides calls to the operating system from Java™ programs or applications executing on data processing system 200 (Java is a trademark of Sun Microsystems, Inc. in the United States, other countries, or both).

Instructions for the operating system, the object-oriented programming system, and applications or programs are located on storage devices, such as hard disk drive 226, and may be loaded into main memory 208 for execution by processor 206. The processes of the present invention are performed by processor 206 using computer implemented instructions, which may be located in a memory such as, for example, main memory 208, read only memory 224, or in one or more peripheral devices.

Those of ordinary skill in the art will appreciate that the hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the present invention may be applied to a multiprocessor data processing system.

In some illustrative examples, data processing system 200 may be a personal digital assistant (PDA), which is configured with flash memory to provide non-volatile memory for storing operating system files and/or user-generated data. A bus system may be comprised of one or more buses, such as a system bus, an I/O bus and a PCI bus. Of course, the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 208 or a cache such as found in north bridge and memory controller hub 202. A processing unit may include one or more processors or CPUs. The depicted examples in FIGS. 1-2 and above-described examples are not meant to imply architectural limitations. For example, data processing system 200 also may be a tablet computer, laptop computer, or telephone device in addition to taking the form of a PDA.

The aspects of the present invention provide a computer implemented method, apparatus, and computer usable program code for temporal sample-based profiling. The aspects of the present invention allow for collection of data in a manner that allows for an ability to provide reports based on a time line when sample-based profiling occurs. In one aspect of the present invention, event information is collected in a bucket during execution of the code to form collected information. These events are identified in response to indicators generated by the system during execution of the code. In these examples, the indicators are interrupts.

The collected information is written into a trace each time a duration or period of time passes. This duration or period of time may be, for example, one second or one minute. The duration may vary depending on the particular implementation or desired report.

After the collected information is written to a trace, the event information is cleared from the bucket. This process is repeated until the tracing completes. In writing the data from the bucket into the trace, identification information is included to identify the data as belonging to a particular period of time or duration of time. This type of identification may include, for example, a time stamp that is associated with the information written from the bucket into the trace.

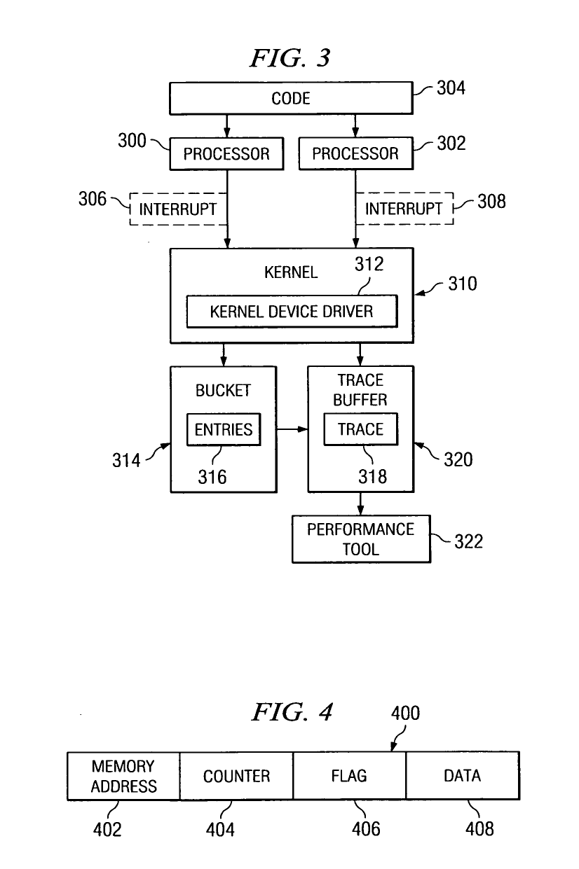

Turning now to FIG. 3, a diagram illustrating components used in temporal sample-based profiling is depicted in accordance with an illustrative embodiment of the present invention. In this example, processor 300 and processor 302 execute code 304. Interrupts 306 and 308 are generated by processors 300 and 302 respectively. These interrupts are received by kernel 310. In particular, a device driver, such as kernel device driver 312, is employed to store information within bucket 314 when an event is identified from an interrupt. In these examples, a device driver is a software program that acts as an extension of the operating system and performs functions that could be implemented as part of the operating system. Often kernel extensions are used to provide functions that are not needed as part of the base operating system, but needed for special purposes, such as performance analysis. In this example, kernel device driver 312 is used to program performance monitor counters and process interrupts from processors, such as processors 300 and 302. In these particular examples, kernel device driver 312 is employed to perform functions for storing data that is generated during the execution of code 304.

Bucket 314 is a work area, and bucket 314 may take various forms. For example, bucket 314 may be a buffer or a linked list. The particular form of bucket 314 will vary depending on the particular implementation. In particular, entries 316 are created and updated within bucket 314. An entry is generated for each address in which an event occurs. Thereafter, whenever another event occurs for an address, a counter in the entry for that address is incremented. This data collection occurs for a period of time or duration.

In this depicted example, after the duration has occurred, the data from the entries are placed into a trace, such as trace 318 within trace buffer 320. In particular, the data from the bucket may be placed into a single trace record or multiple trace records depending on the particular implementation. When data is stored in trace 318, the data is stored as a trace record at this point in time. In writing data from entries 316 in bucket 314 into trace 318, identification information is added to allow performance tool 322 to identify a period of time or duration during which the data was collected. This identification information may take various forms. For example, a time stamp may be added. In placing data into more than one trace record, each trace record may have some maximum size, such as 32K bytes. Each trace record may have identifying information to identify the period of time during which the data was collected.

For example, a trace record may contain a timestamp. Additionally, if all of the information is placed into a single trace record, each trace record represents one time period. If multiple trace records are used when information is transferred from a bucket into the trace, the first trace record in this group of trace records may include an indicator, such as a flag or bit, that is set to show that the beginning of a time period occurs. Additional trace records may have an indicator identifying those records as a continuation of a previous trace record.

After the data has been placed into trace 318, the entries are cleared and data collection occurs again. More specifically, the counter for each entry is set to zero and any invalid entries are removed in clearing the entries. Invalid entries may occur if the memory space changes. The memory space may change and cause an address to no longer be valid. In response to this change, kernel device driver 312 marks that entry as being invalid. If another event is detected by kernel device driver 312 for the same memory address, a new entry is created for that memory address. In these examples, invalid entries are written to trace 318 and then removed.

At some point in time, performance tool 322 processes the data in trace 318 and generates reports or provides a visualization of the information. In an alternative implementation, the aspects of the present invention generate a new bucket for each duration rather than placing data into trace 318 and clearing the bucket. When execution of the code completes, these buckets may be processed by performance tool 322. In this type of implementation, the buckets may be stored sequentially within the work area. As a result, performance tool 322 is able to determine when samples in different buckets occurred. In this type of implementation, the invalid entries are retained for post processing.

Turning now to FIG. 4, a diagram illustrating an entry in a bucket is depicted in accordance with an illustrative embodiment of the present invention. Entry 400 contains memory address 402, counter 404, flag 406, and data 408. Memory address 402 shows the address of the event that is indicated by the interrupt process by the kernel device driver. Counter 404 is used to count the number of events that occur at memory address 402. Flag 406 is used to indicate whether entry 400 is invalid. Data 408 may be other types of data, such as a timestamp that may be stored if entry 400 is marked as being invalid. When entry 400 is written into a trace, memory address 402, counter 404, and data 408 are used to generate one or more trace records. Additionally, a time stamp also may be added to data 408 in the trace record generated. Also, a bucket identifier is included in data 408 to allow a performance tool to identify time periods or durations when the data was collected. In this manner, temporal reports identifying sampling during different periods of time may be generated.

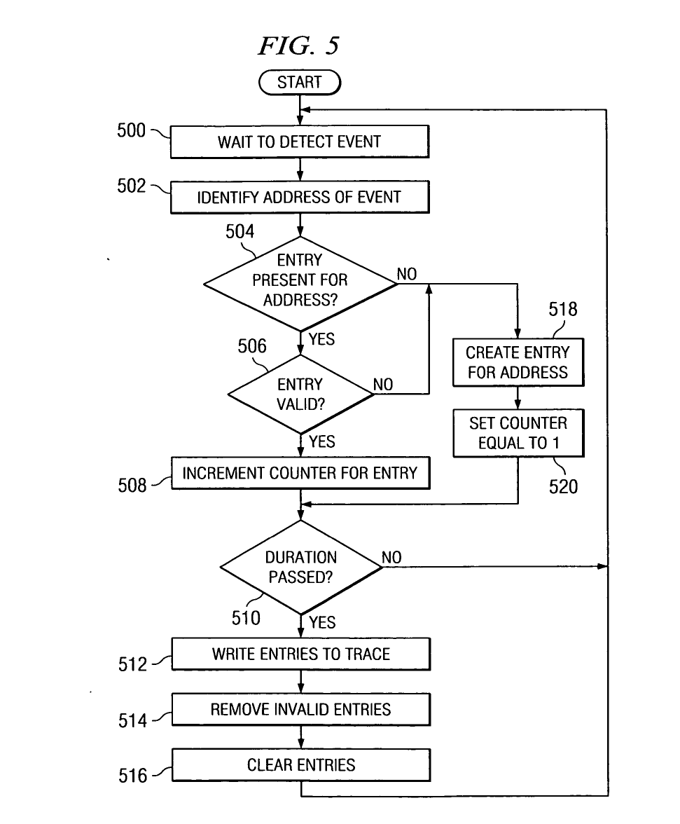

Turning now to FIG. 5, a flowchart of a process for creating entries and placing data in a bucket is depicted in accordance with an illustrative embodiment of the present invention. The process illustrated in FIG. 5 may be implemented in a component, such as kernel device driver 312 in FIG. 3.

The process begins by waiting to detect an event (step 500). In step 500, the process waits to detect an occurrence of an interrupt, such as interrupt 306 or 308 in FIG. 3. This interrupt is used to indicate when an event of interest occurs. The address of the event is identified (step 502). In these examples, the address is identified from the interrupt by reading an instruction pointer located in a machine register. This machine register is normally set when an interrupt occurs. The instruction pointer provides the address for the event.

Thereafter, the process determines whether an entry is present for the address in the event (step 504). If an entry is present with this address, a determination is made as to whether the entry is valid (step 506). In some cases, a memory space change may result in an address becoming invalid. At that point in time, the entry for that address is marked as being invalid. If in step 506, the entry is valid, the process increments a counter in the entry (step 508).

Next, a determination is made as to whether the duration has passed (step 510). In this example, the duration is a period of time that has been set for the bucket. If the duration has not passed, the process returns to step 500 to wait for another event to be detected. Otherwise, the process writes the information from the entries into the trace (step 512). In writing entries into a trace in step 512, bucket identification information is added to the information from the bucket. This bucket identification information enables a performance tool or other analysis program to identify a particular period of time or duration during which the samples were collected. The process then removes any invalid entries from the bucket (step 514). The process clears the remaining entries (step 516) with the process returning to step 500. The entries are cleared by resetting counters to zero in these examples.

With reference again to step 506, if the entry is invalid, the process creates an entry for the address in the event (step 518). In this case, the current entry is for a memory address that is no longer valid because of a change in the memory space. The memory space may change due to different events in the execution of code. For example, a program may complete execution and the associated module(s) may no longer be used in the code. Also, code may be overlayed with different code. This memory space change may happen for various reasons, especially for code generated by a Just-in-Time Compiler (JIT). Any of these types of events results in a memory space change. The process then sets the counter equal to one in this new entry (step 520) with the process proceeding to step 510 as described above. The process also proceeds to step 518 from step 504 if an entry is not present for the address.

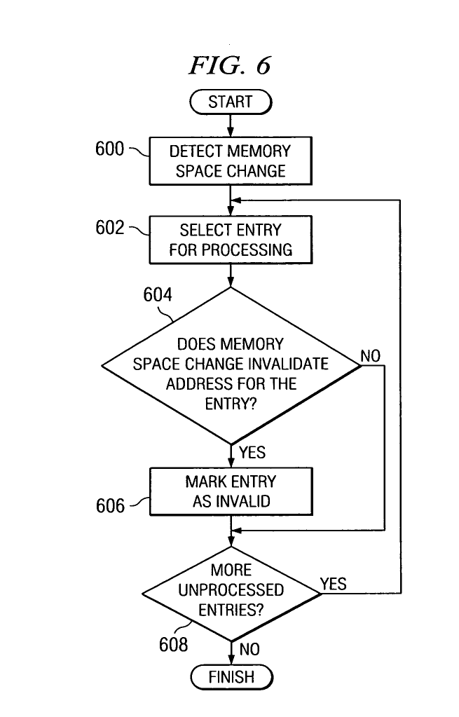

Turning next to FIG. 6, a flowchart of a process used to mark entries as being invalid in response to a memory space change is depicted in accordance with an illustrative embodiment of the present invention. The process illustrated in FIG. 6 may be implemented in a component, such as kernel device driver 312 in FIG. 3.

The process begins by detecting a memory space change (step 600). This memory space change may occur when a module is unloaded or no longer used during the execution of code. Typically, the operating system or applications being profiled provide interfaces to allow the device driver to know when a memory space change has occurred. For example, the device driver may register a request to be notified when a process is started or terminated and modules are loaded or unloaded. In the case of generated application code, a profiler may be attached to the application and receive notification when code is generated with information such as the name of the function, its start address and length. In this case the profiler would need to notify the device driver about the changes in memory space. The device driver must keep track of the validity of the memory space and changes. It may keep a linked list by process containing valid address ranges and use this information in its processing. The process selects an entry in the bucket for processing (step 602). Thereafter, a determination is made as to whether the memory space change invalidates the address in the entry (step 604). If the memory space change invalidates this entry, the process marks the entry as invalid (step 606). In these examples, the marking of an entry may be accomplished through a number of different mechanisms. For example, the setting of a flag, such as flag 406 in FIG. 4 may occur. Thereafter, the process determines whether additional unprocessed entries are present in the bucket (step 608). If additional unprocessed entries are not present, the process terminates. Otherwise, the process returns to step 602 to select another entry for processing. With reference again to step 604, if the memory space change does not invalidate this entry, the process proceeds to step 608 as described above.

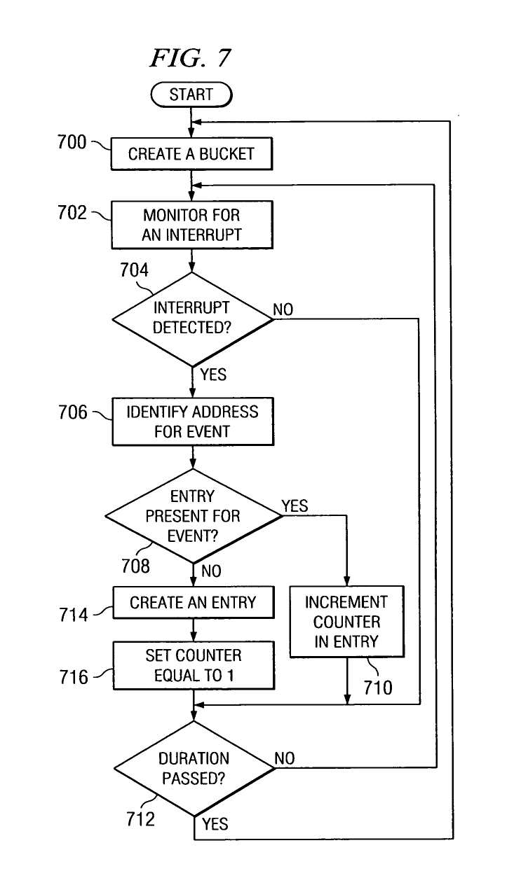

Turning now to FIG. 7, a flowchart of a process for storing data in buckets is depicted in accordance with an illustrative embodiment of the present invention. This process is an alternative embodiment in which multiple buckets are generated in collecting data. The process illustrated in FIG. 7 may be implemented using a kernel component, such as kernel device driver 312 in FIG. 3.

The process begins by creating a bucket (step 700). In this example, a bucket is created for each duration or period of time that occurs during execution of the code. The process then monitors for an interrupt (step 702). Next, a determination is made as to whether an interrupt is detected (step 704). If an interrupt is detected, the process identifies the address for the event (step 706). A determination is made as to whether an entry is present for the event (step 708). This determination is made by looking to see whether the address is present in a valid entry within the bucket. If an entry is present for the event, the process increments the counter in the entry (step 710).

Thereafter, a determination is made as to whether the duration has passed (step 712). If the duration has not completed, the process returns to step 702 to monitor for another interrupt. Otherwise, the process returns to step 700 to create another bucket.

With reference again to step 708, if an entry is not present for the event, the process creates a new entry for the event (step 714), and sets the counter in the entry to one (step 716). The process then proceeds to step 712 as described above. Turning back to step 704, if an interrupt is not detected, the process also proceeds to step 712.

With this particular implementation, the data is separated by time periods in the different buckets. This type of implementation is in contrast to the other illustrative embodiments in which the data from the bucket is stored into a trace each time the duration terminates. Alternative approaches that compress the amount of data written may be used. Simple techniques such as putting out each address only once and using some type of index or specific ordering for writing out updated counts or delta counts also may be used.

Thus, the aspects of the present invention provide a computer implemented method, apparatus, and computer usable program code for collecting event information. In particular, this event information is used to provide temporal sample-based profiling. By collecting information during the execution of code in a manner in which the information during different time periods may be identified, reports may be generated for different time periods during the execution of the trace. In this manner, reports may be generated for different time periods of interest.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for collecting event information, the computer implemented method comprising:
collecting event information in a bucket during execution of code to form collected event information;
writing the collected event information in a trace each time a period of time passes;
associating the time period with the event information; and
clearing the collected event information from the bucket each time the collected event information is written to the trace.

2. The computer implemented method of claim 1, wherein the collecting step comprises:
responsive to an event having an address occurring during execution of the code, determining whether an entry for the address is present in the bucket; and
incrementing a counter for the entry if the address is present in the entry.

3. The computer implemented method of claim 2, wherein the collecting step further comprises:
creating the entry for the address if the entry is absent from the bucket; and
setting the counter for the entry to one.

4. The computer implemented method of claim 2, wherein the clearing step comprises:
resetting the counters in the bucket to zero.

5. The computer implemented method of claim 2 further comprising:
responsive to detecting a memory space change, marking entries having an invalid address as invalid.

6. The computer implemented method of claim 5 further comprising:
creating a new entry if an event is collected for an address in an entry marked as being invalid.

7. The computer implemented method of claim 5, wherein the clearing step comprises:
removing entries marked as invalid from the bucket; and
resetting the counters in the bucket to zero.

8. The computer implemented method of claim 1 further comprising:
generating a report using the trace.

9. The computer implemented method of claim 1, wherein the computer implemented method is located in a driver in an operating system.

10. A computer program product comprising:
a computer usable medium having computer usable program code for collecting event information, the computer program product including:
computer usable program code for collecting event information in a bucket during execution of code to form collected event information;
computer usable program code for writing the collected event information in a trace each time a period of time passes;
computer usable program code for associating the time period with the event information; and
computer usable program code for clearing the collected event information from the bucket each time the collected event information is written to the trace.

11. The computer program product of claim 10, wherein the computer usable program code for collecting event information in a bucket during execution of code to form collected event information comprises:
computer usable program code, responsive to an event having an address occurring during execution of the code, for determining whether an entry for the address is present in the bucket; and
computer usable program code for incrementing a counter for the entry if the address is present in the entry.

12. The computer program product of claim 11, wherein the computer usable program code for collecting event information in a bucket during execution of code to form collected event information further comprises:
computer usable program code for creating the entry for the address if the entry is absent from the bucket; and
computer usable program code for setting the counter for the entry to one.

13. The computer program product of claim 11, wherein the computer usable program code for clearing event information from the bucket each time the collected event information is written to the trace comprises:
computer usable program code for resetting the counters in the bucket to zero.

14. The computer program product of claim 11 further comprising:
computer usable program code, responsive to detecting a memory space change, for marking entries having an invalid address as invalid.

15. The computer program product of claim 14 further comprising:
computer usable program code for creating a new entry if an event is collected for an address in an entry marked as being invalid.

16. The computer program product of claim 14, wherein the computer usable program code for clearing event information from the bucket each time the collected event information is written to the trace comprises:
computer usable program code for removing entries marked as invalid from the bucket; and
computer usable program code for resetting the counters in the bucket to zero.

17. A data processing system comprising:
a bus;
a communications unit connected to the bus;
a memory connected to the bus, wherein the memory includes a set of instructions; and
a processor unit connected to the bus, wherein the processor unit executes the computer usable code to collect event information in a bucket during execution of code to form collected event information; write the collected event information in a trace each time a period of time passes; associate the time period with the event information; and clear the collected event information from the bucket each time the collected event information is written to the trace.

18. The data processing system of claim 17, wherein the processor unit further executes the computer usable code to determine whether an entry for the address is present in the bucket in response to an event having an address occurring during execution of the code; and increment a counter for the entry if the address is presenting in the entry.

19. A computer implemented method for generating a report, the computer implemented method comprising:
identifying temporal sampling attributes for a set of buckets; and
collecting event information in the set of buckets using the temporal sampling attributes; and
generating a report using the event information in the set of buckets.

20. The computer implemented method of claim 19, wherein the set of buckets is located in a work area comprising one of a set of buffers and a linked list.
